(19) United States
(12) Patent Application Publication
(10) Pub. No.: US 2023/0151680 A1
(43) Pub. Date: May 18, 2023

(54) WINDOW OR DOOR HAVING AN ACTIVELY PRESSING SEAL AND METHOD FOR CLOSING SAID WINDOW OR DOOR

(71) Applicant: Roto Frank Fenster- und Türtechnologie GmbH, Leinfelden-Echterdingen (DE)

(72) Inventors: Fabian Praeg, Filderstadt (DE); Marko Budarick, Stuttgart (DE); Eric-Maria Heimann, Stuttgart (DE); Juergen Daub, Falkensee (DE); Frank Nolting, Leinfelden-Echterdingen (DE)

(73) Assignee: Roto Frank Fenster- und Türtechnologie GmbH, Leinfelden-Echterdingen (DE)

(21) Appl. No.: 18/055,931

(22) Filed: Nov. 16, 2022

(30) Foreign Application Priority Data
Nov. 18, 2021 (GB) 2 116 672.3

(51) Int. Cl. E06B 7/20; E06B 3/44

(52) U.S. Cl. CPC E06B 7/20; E06B 3/4415

(57) ABSTRACT

A window or door includes a fixed frame with a first sash arranged displaceable thereon. A seal is arranged on the fixed frame, the sealing lip of which can be moved or pivoted and pressed onto the front or rear of the first sash. The moving process can be carried out by at least one first trigger element or by a plurality of trigger elements. The first trigger element or the trigger elements can be actuated by a first projection or a plurality of projections. A first wedge seal can be provided between the first sash and the fixed frame, which is preferably wedge-shaped both in the main plane of the frame and perpendicular to the main plane of the frame. Between two sashes, in the region of the central break, L-shaped seals can be provided which engage one behind the other in the closed state of the two sashes.

### CROSS-REFERENCE TO RELATED APPLICATION

This application claims priority to United Kingdom Patent Application No. GB 2 116 672.3, filed Nov. 18, 2021, the entire contents of which are hereby incorporated in full by this reference.

### DESCRIPTION

### Field of the Invention

The invention relates to a window or door having a fixed frame, a sliding sash, which is slidable with respect to the fixed frame and a seal for sealing the first sash with respect to the fixed frame. In case of a window with a vertically sliding sash, such a window is also known as a “hung window.” The invention also relates to a method for closing such a window or door.

### Background of the Invention

The structure of a vertical sliding window with a plurality of frame parts is known from JP 4908836 B2.

EP 3 214 250 B1 discloses a vertical sliding window for a building. A drive for raising and lowering a sliding sash is provided.

A plastering strip for a transition between thermal insulation and a window frame is known from EP 3 130 722 B1.

US 2,426,474 A discloses guides for sliding windows.

From US 4,395,847 A, a sliding window having improved seals is known. The sliding window can have a handle that can be pivoted by a user in order to be able to lock a slidable sash of the sliding window in different positions.

US 31,721 E discloses a sliding window having seals for a slidable and pivotable sash.

From CN 101864883 A, sliding windows having different seals are known. The seals are fastened to the fixed frame and are pressed against a side surface of a slidable sash in the closed position.

The sealing of these known windows, in particular against drafts, is significantly worse than the sealing of comparable side-hung windows or side– and bottom–hung windows. In order to save energy, the sealing of the windows described above (or doors) should be improved.

### SUMMARY OF THE INVENTION

### Object of the Invention

It is therefore the object of the invention to provide a window or door that is significantly better sealed in its closed position. It is a further object of the invention to provide a method for closing such a window or door.

### Description of the Invention

This object is achieved according to the invention by a window or door according to claim 1 and a method according to claim 15. The dependent claims describe preferred embodiments.

The object of the invention is thus achieved by a window or door having a fixed frame, a first sash that is slidable, preferably within the fixed frame, and a seal for sealing the first sash with respect to the fixed frame. The seal has a fastening element for fastening the seal to the fixed frame, a holding element having a sealing lip, a joint for moving , in particular pivoting, the holding element with respect to the fastening element, and a trigger element. The trigger element is actuated by the first sash when the first sash is closed, so that the sealing lip is moved, preferably pivoted, onto the first sash and pressed onto the first sash.

According to the invention, a sealing lip is thus provided which is actively pressed onto the first sash when the first sash is closed, so that a significantly better seal takes place. This is particularly true in the case of a first sash that has play in the fixed frame, in particular a groove in the fixed frame, so that the first sash can be easily moved with respect to the fixed frame.

The sealing lip is preferably pressed onto the first sash only after reaching at least 90%, in particular at least 95%, particularly preferably at least 98%, of the closed position of the first sash.

The first sash can have a surface facing a user, which is referred to as the front (inside) and a surface facing away from the user, which is referred to as the rear (outside). The sealing lip is particularly preferably pressed onto this front or rear, in particular the front, when the first sash is closed. A particularly good sealing effect is achieved in this way.

The joint can be built as a sliding joint and/or a swivel joint.

The joint between the holding element and the fastening element can be designed in one piece, in particular in the form of a film hinge. However, the joint is preferably designed in at least two parts in order to maintain the durability of the joint even after many closing movements of the first sash.

Particularly preferably, a rounded projection of the joint is arranged or formed on the fastening element, which is at least partially encompassed by a compatible/corresponding/matching opening of the holding element. This ensures a particularly durable joint with a structurally simple and inexpensive design.

The sealing lip can be formed in one piece/integrally with the holding element. However, the holding element is preferably formed separately from the sealing lip.

More preferably, the holding element is designed to be rigid, so that the holding element is moved, in particular pivoted, as a whole when the trigger element is actuated. This ensures complete and uniform contact between the sealing lip and the first sash.

The trigger element can be designed in the form of a protrusion, in particular in the form of a flag-shaped protrusion. The trigger element can be arranged or formed on the holding element.

A first projection, in particular a ramp-shaped, first projection, can be arranged or formed on the first sash for actuating the first trigger element.

In addition to this – viewed in the closing direction of the first sash – a, in particular ramp-shaped, second projection for actuating a second trigger element of the seal can be provided in front of the first projection.

The first projection and the second projection can be formed identically.

The first projection can be arranged or formed at a more distant location perpendicular to the central main plane of the frame than the second projection. The first trigger element can be formed longer for actuation by the first projection than the second trigger element for actuation by the second projection. This can ensure that the sealing lip is only pressed against the first sash when the first sash is almost completely closed.

The window or door can have a third projection on the first sash for actuating a third trigger element of the seal. The third projection can – viewed in the closing direction of the first sash – be provided in front of the second projection. The third projection can be provided closer to the central frame main plane than the second projection and the third trigger element can be made shorter than the second trigger element for actuating the third projection.

This arrangement can ensure that all trigger elements are actuated by the respective projections at the same time / at the same position of the sash.

The sealing lip preferably runs parallel to the closing direction of the first sash.

The seal described above can additionally be provided on the opposite side of the first sash, in particular in a mirror-inverted manner.

In a particularly preferred embodiment of the invention, the first sash has an end face running parallel to its closing direction, a first wedge seal running obliquely in the main plane of the frame being provided between this end face and the fixed frame. More preferably, the first sash has a first wedge seal running obliquely in the main plane of the frame between the respective end faces and the fixed frame on both end faces running parallel to the closing direction.

A first wedge seal running obliquely perpendicular to the main plane of the frame can be provided between the end face of the first sash running parallel to the closing direction of the first sash and the fixed frame. More preferably, the first sash has a first wedge seal running obliquely perpendicular to the main plane of the frame between the respective end faces and the fixed frame on both end faces running parallel to the closing direction.

In a further preferred embodiment of the window or door, a first wedge seal running obliquely in the main plane of the frame as well as obliquely perpendicular to the main plane of the frame is provided between the corresponding end faces of the first sash and the fixed frame on both front sides of the first sash running parallel to the closing direction.

The wedge seal(s) described herein or a window or door with a fixed frame, at least one first sash and at least one wedge seal represent an independent aspect of the invention, which can be combined with any of the features described herein.

In order to properly seal the end face of the first sash running perpendicular to the closing direction, a static seal is preferably provided between this end face, in particular on this end face, and the fixed frame. Such a static seal can preferably be installed on the lower end of the first sash and/or on the upper end of the first sash.

For a particularly reliable sealing of the window or door, a molded corner part can be provided between the static seal and the fastening element.

The first sash can be slidable vertically.

The terms “above,” “below,” “vertical,” “horizontal,” and the like generally refer to the installed state of the window or door in a building.

The window or door can have a slidable second sash, which overlaps with the first sash in the region of a so-called central break when both sashes are in the closed position.

The wedge seal(s) described herein is/are preferably installed in the area of this central break, only.

The previously described seal(s) between the first sash and the fixed frame can be provided between the second sash and the fixed frame, analogously to this/these, as an alternative or in addition thereto.

The first sash and the second sash can each have a seal, which is L-shaped in cross section in the region of the central break. The seals, which are L-shaped in cross section can engage behind one another in the closed position of both sashes. This creates a particularly windproof seal between the two sashes.

A window or door having a first sash, a second sash, and a seal, which seal is described herein and which is L-shaped in cross section, represents an independent aspect of the invention which can be combined with any of the features described herein.

The object according to the invention is also achieved by a method for closing a window or door described herein, the method comprising the following method steps:
A) Sliding the first sash from its open position to its closed position;
B) Actuating the trigger element by the first sash and thereby moving, in particular pivoting, the sealing lip onto the first sash.

Further advantages of the invention can be found in the description and the drawings. Likewise, according to the invention, the aforementioned features and those which are to be explained below can each be used individually for themselves or for a plurality of combinations of any kind. The embodiments shown and described are not to be understood as an exhaustive enumeration but rather have exemplary character for the description of the invention.

### BRIEF DESCRIPTION OF THE DRAWINGS

FIG. 1 is an isometric view of a window with a fixed frame and a closed first sash.

FIG. 2 is an isometric view of the window from FIG. 1 with the first sash partially open.

FIG. 3 is a partial isometric view of the first sash.

FIG. 4 is a partial isometric view of the underside of the first sash with a static seal.

FIG. 5 is an isometric view of a seal, which can be partially pivoted onto the first sash and has a plurality of trigger elements.

FIG. 6 is a view of the end face of the seal from FIG. 5 in a partially pivoted state.

FIG. 7 is an end face view of the window with the seal of FIG. 5 fastened to the fixed frame and a plurality of projections on the first sash for actuating the plurality of trigger elements.

FIG. 8 is a view of a projection shortly before the actuation of a trigger element.

FIG. 9a is a view of the projection from FIG. 8 upon contact with the trigger element.

FIG. 9b is a view of the end face of the seal of FIG. 9a.

FIG. 10a is a view of the projection of FIG. 9a with the trigger element actuated completely by the projection.

FIG. 10b is a view of the end face of the seal of FIG. 10a.

FIG. 11a is a partial view of the window in the region of the central break with seals tapering in a wedge shape, the seals being on the first sash and on a second sash.

FIG. 11b is a plan view of the wedge-shaped tapered seals of FIG. 11a.

FIG. 12 is an isometric view of a sealing member corresponding to wedge-shaped sealing parts shown in FIGS. 11a and 11b.

FIG. 13a is an isometric view of the closed seal in the region of the central break.

FIG. 13b is a side view of the closed seal of FIG. 13a.

FIG. 14 is a sectional view of the closed window in the region of the central break.

### DETAILED DESCRIPTION OF THE PREFERRED EMBODIMENTS

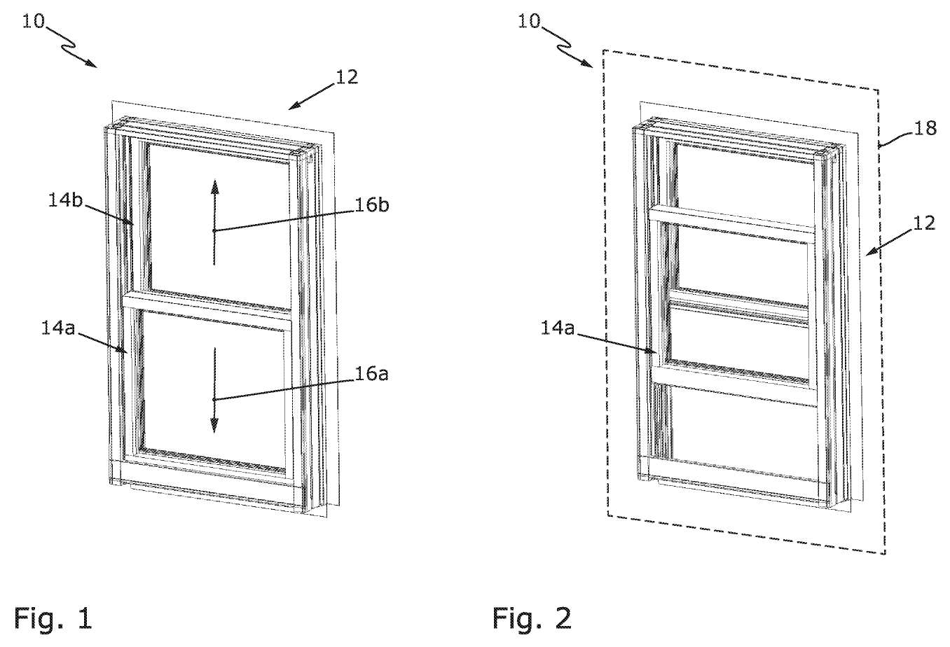

FIG. 1 shows a window 10 from the inside having a fixed frame 12, a first sash 14a, and a second sash 14b. The first sash 14a can be displaced downward in the closing direction 16a, the second sash 14b can be displaced upward in the closing direction 16b. The displacement of the first sash 14a and/or the displacement of the second sash 14b preferably takes place completely within the fixed frame 12. The window 10 is completely closed in FIG. 1, i.e., both sashes 14a, b are closed. The second sash 14b could also be designed in the form of an immovable fixed field.

FIG. 2 shows the window 10 with the first sash 14a partially open. From FIG. 2, it can be seen that the fixed frame 12 extends in a central main plane 18 of the frame.

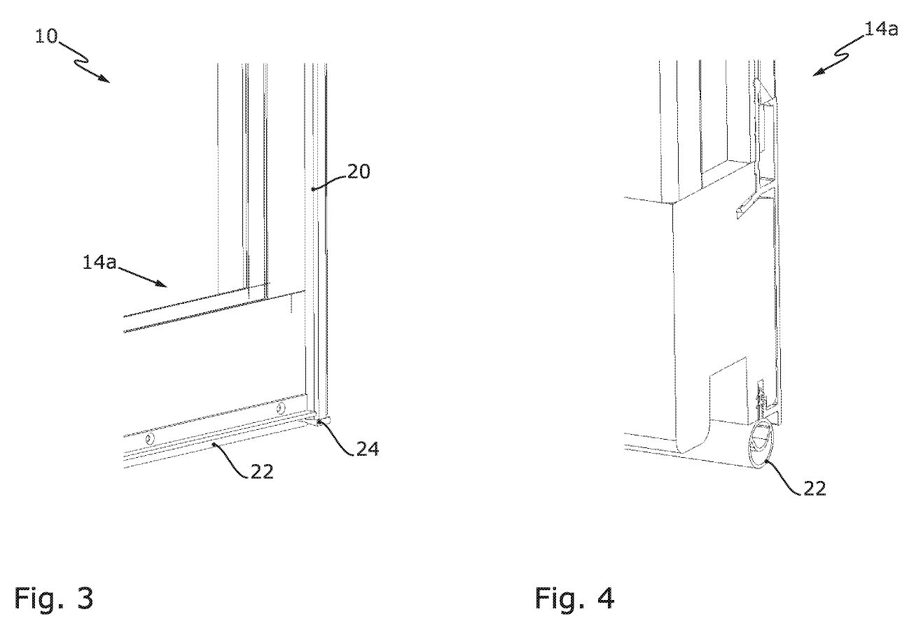

FIG. 3 shows part of the window 10 having the first sash 14a. The first sash 14a is laterally sealed by a seal 20 that can be pivoted in itself. The first sash 14a is sealed on the underside by a static seal 22. A molded corner part 24 is provided between the pivotable seal 20 and the static seal 22.

FIG. 4 shows the first sash 14a with the static seal 22 in a detailed representation.

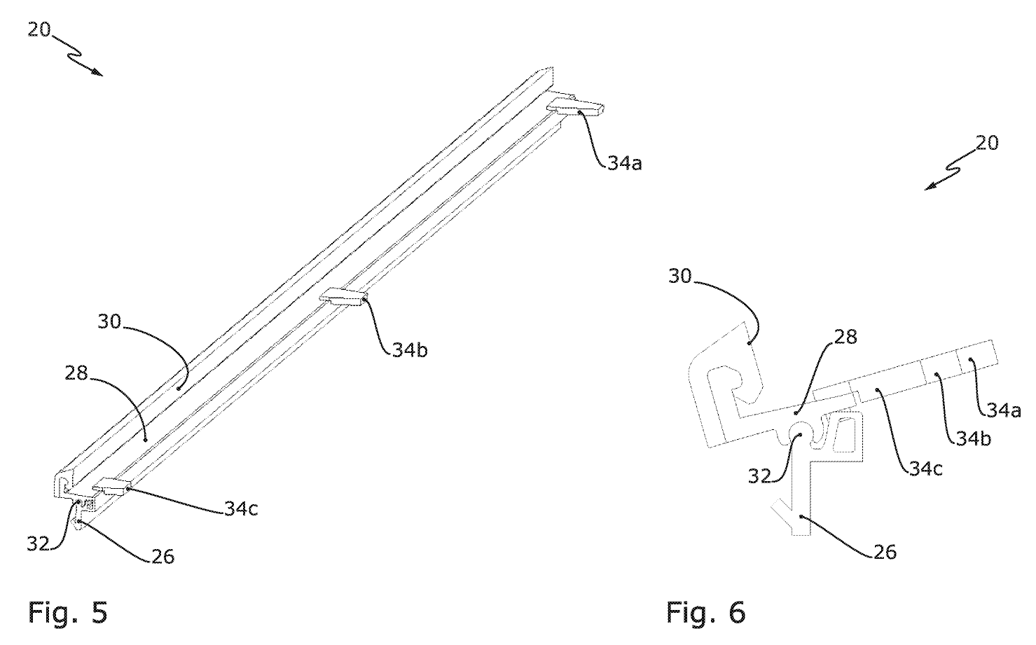

FIG. 5 and FIG. 6 show the seal 20 with a fastening element 26 that can be fastened to the fixed frame 12 (see FIG. 1), a holding element 28 with a sealing lip 30, a joint 32 for pivoting the holding element 28 with respect to the fastening element 26, a first trigger element 34a, a second trigger element 34b, and a third trigger element 34c.

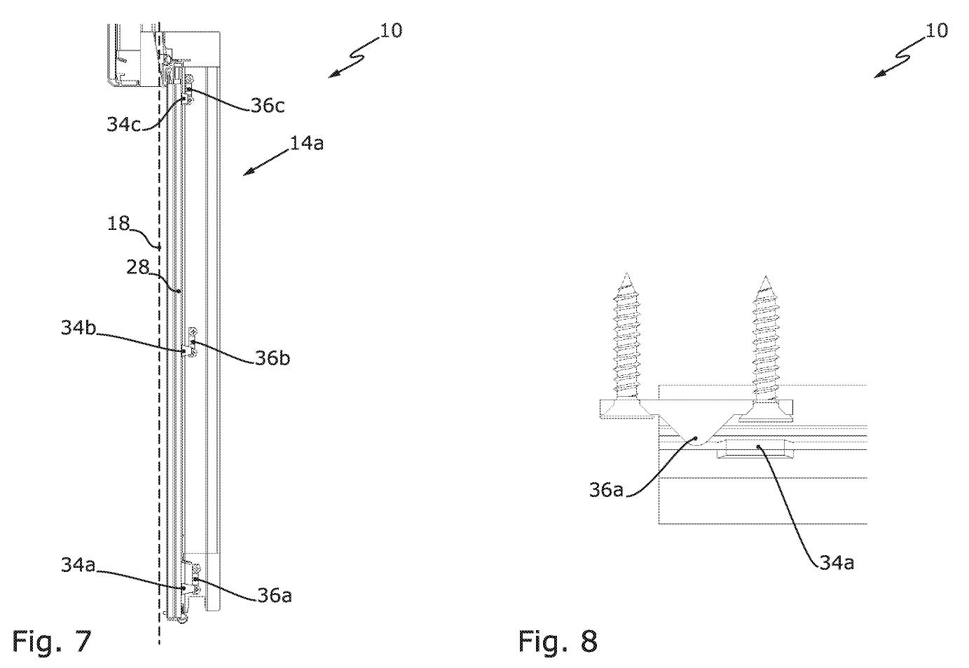

FIG. 7 shows the window 10 with the first sash 14a, on which a first projection 36a for actuating the first trigger element 34a, a second projection 36b for actuating the second trigger element 34b and a third projection 36c for actuating the third trigger element 34c are arranged. The second trigger element 34b is formed longer than the third trigger element 34c. The first trigger element 34a is formed longer than the second trigger element 34b. The second projection 36b is correspondingly further spaced from the central main plane 18 of the frame and/or the holding element 28 than the third projection 36c. The first projection 36a is correspondingly further spaced from the central main plane 18 of the frame and/or the holding element 28 than the second projection 36b. As a result, the plurality of trigger elements 34a-c, in this case three trigger elements 34a-c, are actuated simultaneously, but only shortly before the first sash 14a is completely closed.

FIG. 8 shows a part of the window 10, from which it can be seen that the first projection 36a is designed so as to be ramp-shaped for simple actuation of the first trigger element 34a. The first projection 36a is not yet in contact with the first trigger element 34a.

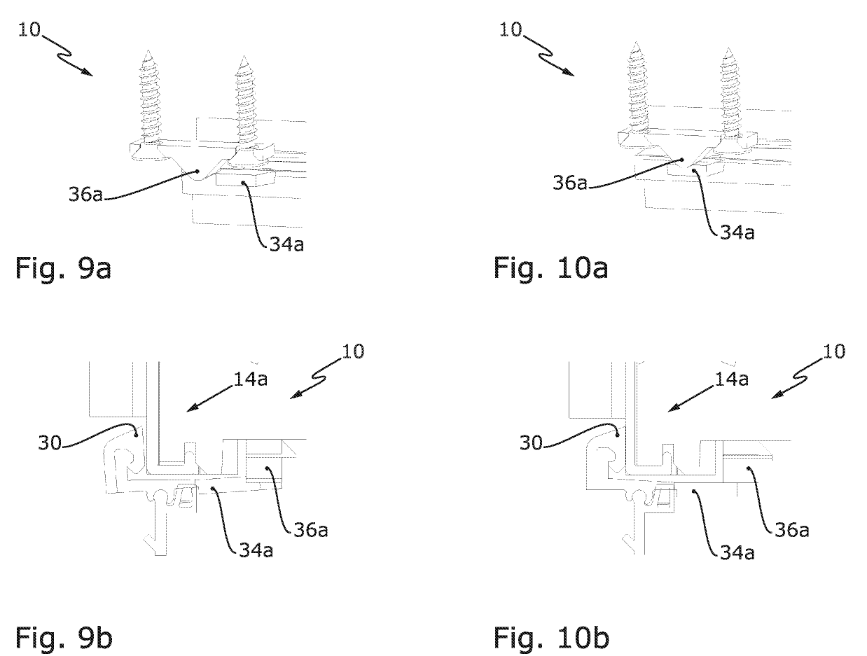

FIG. 9a and FIG. 9b show the window 10, the first projection 36a being in contact with the first trigger element 34a. As a result, the sealing lip 30 is pivoted toward the first sash 14a.

FIG. 10a and FIG. 10b correspond to FIGS. 9a and 9b, the first projection 36a being in complete contact with the first trigger element 34a, so that the sealing lip 30 is pressed onto the first sash 14a and reliably seals it.

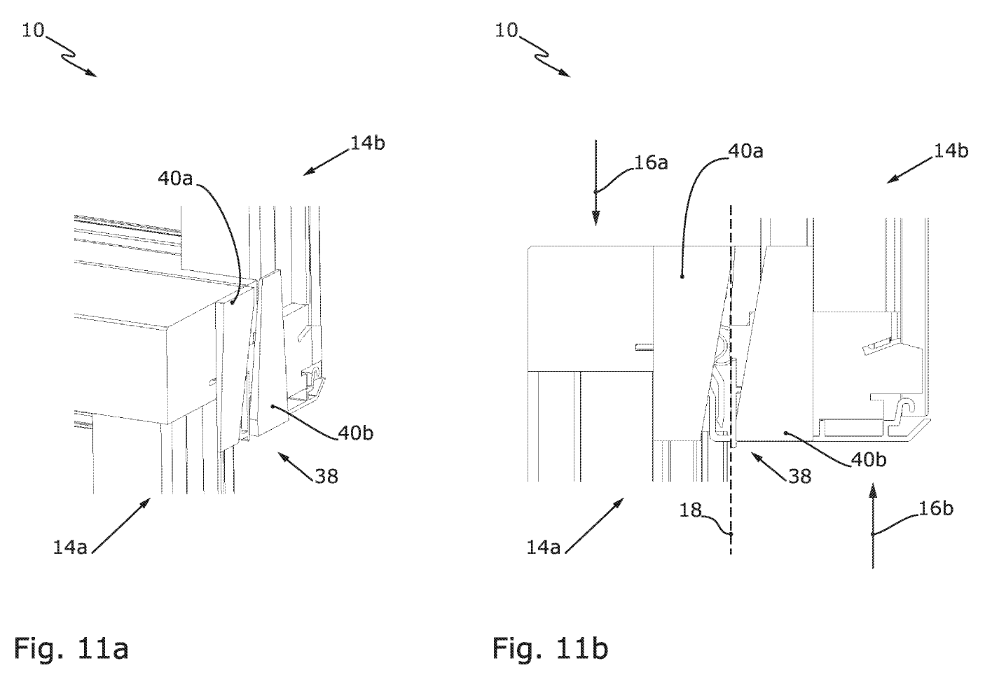

FIG. 11a and FIG. 11b show in a synopsis the window 10 in the region of the central break 38 between the sashes 14a, b. The first sash 14a has a first sealing part 40a, which thickens in a wedge-shaped manner counter to the closing direction 16a parallel to the main plane 18 of the frame. The second sash 14b has a second sealing part 40b, which thickens in a wedge-shaped manner counter to the closing direction 16b parallel to the main plane 18 of the frame. From FIG. 11b, it can also be seen that the sealing parts 40a, b thicken in a wedge-shaped manner not only parallel to the main plane 18 of the frame, but also perpendicular to the main plane 18 of the frame against the closing direction 16a or 16b.

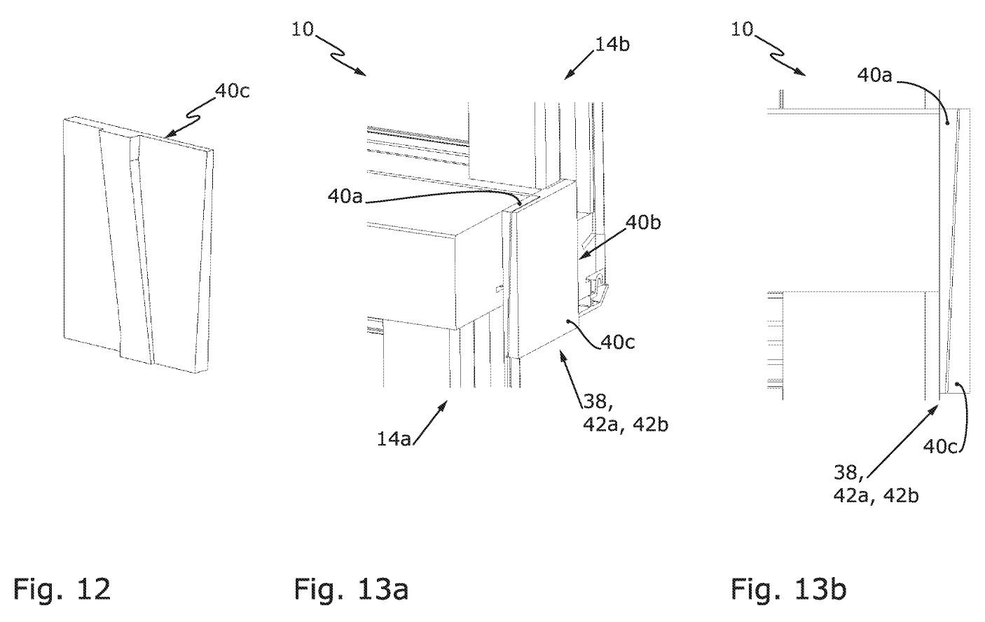

FIG. 12 shows a third sealing part 40c with slopes which correspond to the slopes of the sealing parts 40a, b. The third sealing part 40c can be designed in multiple parts. However, as in the present case, it is preferably designed in one piece.

FIG. 13a and FIG. 13b show part of the window 10 in the region of the central break 38, the sealing parts 40a-c forming a first wedge seal 42a between the first sash 14a and the fixed frame 12 (see FIG. 1) and forming a second wedge seal 42b between the second sash 14b and the fixed frame 12.

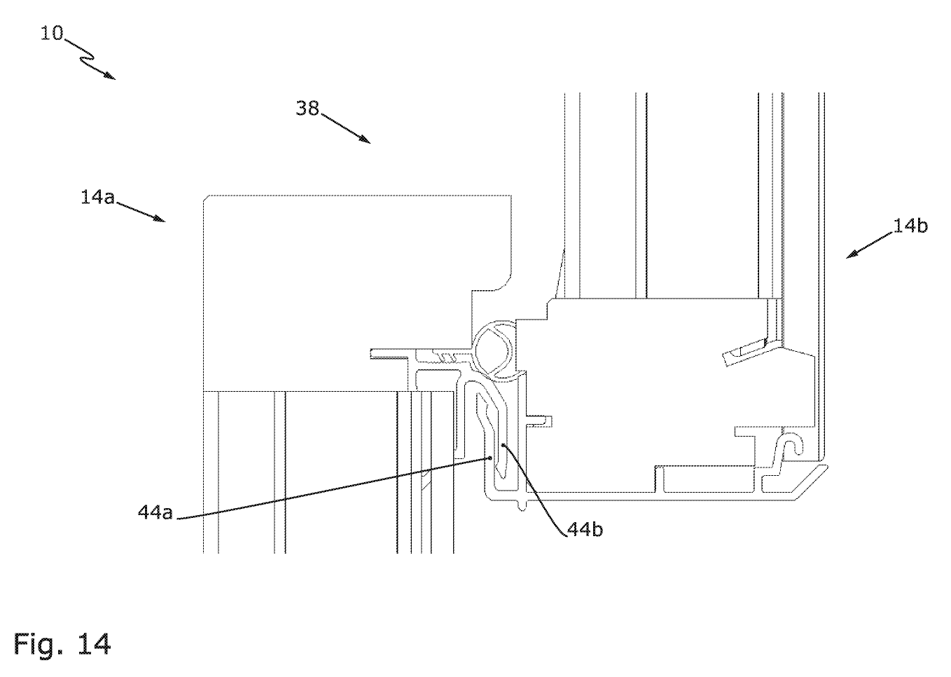

FIG. 14 is a partial sectional view of the window 10 in the region of the central break 38. From FIG. 14, it can be seen that the first sash 14a has a first seal 44a which is L-shaped in cross section and the second sash 14b has a second seal 44b which is L-shaped in cross section. The two seals 44a, b which are L-shaped in cross section engage behind one another in the closed state of the two sashes 14a, b.

Taking all the figures of the drawing together, the invention relates in summary to a window 10 or door having a fixed frame 12 and to a first sash 14a arranged displaceable thereon. A seal 20 is arranged or formed on the fixed frame 12, the sealing lip 30 of which can be moved, in particular pivoted, and pressed onto the first sash 14a, in particular onto the front or rear of the first sash 14a. The moving, in particular pivoting, process can be carried out by at least one first trigger element 34a, in particular by a plurality of trigger elements 34a-c. The first trigger element 34a or the trigger elements 34a-c can be actuated by a first projection 36a or a plurality of projections 36a-c. A first wedge seal 42a can be provided between the first sash 14a and the fixed frame 12, which is preferably wedge-shaped both in the main plane of the frame 18 and perpendicular to the main plane 18 of the frame 12. Between two sashes 14a, b, in the region of the central break 38, seals 44a, b which are L-shaped in cross section can be provided, which engage behind one another in the closed state of the two sashes 14a, b.

List of reference numbers

| | |
|---|---|
| 10 | Window |
| 12 | Fixed frame |
| 14 a | First sash |
| 14 b | Second sash |
| 16 a | Closing direction of the first sash 14a |
| 16 b | Closing direction of the second sash 14b |
| 18 | Main plane of the frame |
| 20 | Pivotable seal |
| 22 | Static seal |
| 24 | Molded corner part |
| 26 | Fastening element |
| 28 | Holding element |
| 30 | Sealing lip |
| 32 | Joint |
| 34 a | First trigger element |
| 34 b | Second trigger element |
| 34 c | Third trigger element |
| 36 a | First projection |
| 36 b | Second projection |
| 36 c | Third projection |
| 38 | Central break |
| 40 a | First sealing part |
| 40 b | Second sealing part |
| 40 c | Third sealing part |
| 42 a | First wedge seal |
| 42 b | Second wedge seal |
| 44 a | First seal, being L-shaped in cross section |
| 44 b | Second seal, being L-shaped in cross section |

What is claimed is:

1. A window or door having a fixed frame, comprising:
a first sash which is slidable with respect to the fixed frame; and
a seal for sealing the first sash with respect to the fixed frame;
wherein the seal has the following:
a) a fastening element arranged or formed on the fixed frame;
b) a holding element having a sealing lip;
c) a joint for moving the holding element with respect to the fastening element; and
d) a first trigger element which can be actuated by the first sash, wherein the sealing lip is moved and pressed onto the first sash by the closing of the first sash.

2. The window or door according to claim 1, in which a front and a rear of the first sash run parallel to the main plane of the frame, the main plane running through the center of the fixed frame, and the sealing lip is moved and pressed onto the front or rear of the first sash by the closing of the first sash.

3. The window or door according to claim 1, in which the joint is constructed in two parts.

4. The window or door according to claim 1, in which the holding element is rigid, and wherein the holding element is moved uniformly and completely when the first trigger element is actuated.

5. The window or door according to claim 1, wherein the first trigger element is designed in the form of a flag-shaped protrusion.

6. The window or door according to claim 1, wherein a first projection for actuating the first trigger element is arranged or formed on the first sash.

7. The window or door according to claim 6, wherein a second projection for actuating a second trigger element of the seal is provided on the first sash, the second projection being behind the first projection in the closing direction of the first sash.

8. The window or door according to claim 7, wherein the first projection is arranged or formed more distant from the central main plane of the frame than the second projection, and the first trigger element is formed longer for actuation by the first projection than the second trigger element (34b) for actuation by the second projection.

9. The window or door according to claim 1, wherein a first wedge seal running obliquely in the main plane of the frame is provided between the end face of the first sash and the fixed frame, the end face running parallel to the closing direction of the first sash.

10. The window or door according to claim 1, wherein a first wedge seal running obliquely perpendicular to the main plane of the frame is provided between the end face of the first sash and the fixed frame, the end face running parallel to the closing direction of the first sash.

11. The window or door according to claim 1, wherein a static seal is provided between the end face of the first sash running perpendicular to the closing direction of the first sash and the fixed frame.

12. The window or door according to claim 11, wherein a molded corner part is provided in the corner region between the static seal and the fastening element.

13. The window or door according to claim 1, wherein the window has a slidable second sash, wherein the first sash and the second sash overlap in the region of a central break when both sashes are in the closed position.

14. The window or door according to claim 13, wherein the first sash and the second sash each have a seal which is L-shaped in cross section in the region of the central break, which seals engage behind one another when both sashes are in the closed position.

15. A method for closing the window or door according to claim 1, comprising the method steps of:
A) sliding the first sash from its open position into the closed position; and
B) actuating the first trigger element by the first sash and thereby moving the sealing lip onto the first sash.
